(19) United States
(12) Patent Application Publication
(10) Pub. No.: US 2003/0055606 A1
(43) Pub. Date: Mar. 20, 2003

(54) "Medical system for monitoring geriatric-psychiatric patients in an ambient living environment"

(76) Inventors: Tilo Christ, Erlangen (DE); Peter Leupold, Nuernberg (DE); Volker Schmidt, Erlangen (DE); Werner Striebel, Schwarzenbruck (DE)

Correspondence Address: SCHIFF HARDIN & WAITE, 6600 SEARS TOWER, 233 S WACKER DR, CHICAGO, IL, 60606-6473, US

(21) Appl. No.: 10/153,994

(22) Filed: May 23, 2002

(30) Foreign Application Priority Data
May 23, 2001 (DE) 10125550.0

(51) Int. Cl. G06F 15/00

(52) U.S. Cl. 702/188

(57) ABSTRACT

A medical system for continuously monitoring geriatric-psychiatric patients in a home environment, a senior's home or in a nursing home, has a device for acquiring events at the patient such as confused states, falls, aggressivity, wandering, immobility and/or medication side effects, a device for transmitting the acquired data of the events to a system center, and a reception device at a monitoring person. The system center has a memory for the data of the acquired events and predetermined undesired events, an evaluation device for the data with a comparator for comparing the data to the stored reference values of the predetermined undesired events, an alarm device for generating an alarm signal, and a routing device for forwarding the alarm signal to a reception device of a person to be alerted in a process (response) chain.

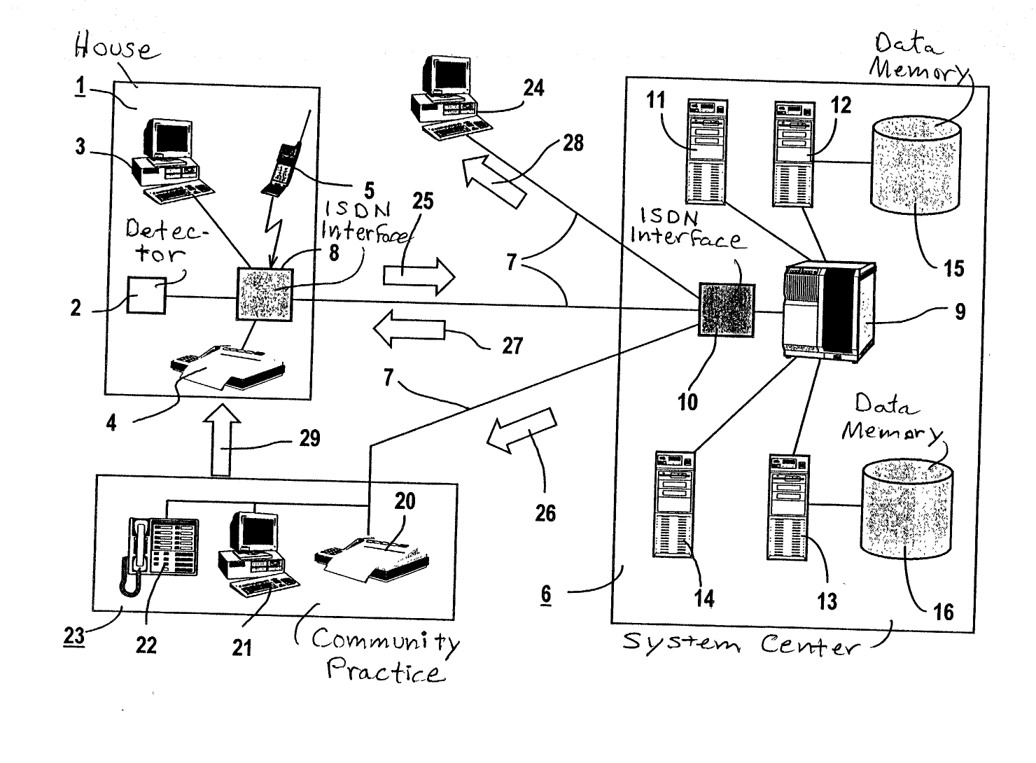

### BACKGROUND OF THE INVENTION

1. Field of the Invention

The present invention is directed to a system for continuously monitoring geriatric-psychiatric patients in an ambient living environment, such as a residential home, a senior's home or a nursing home. The invention is directed essentially to the care of geronto-psychiatric patients having senile dementia or cerebral-organic psychosyndrome (HOPS).

2. Description of the Prior Art

A particular medical problem is the care of geriatric-psychiatric patients at home, in seniors homes and nursing homes within the framework of visits by the physician or by care givers. A goal is to continuously recognize which patients having a need for medical treatment in order to be able to efficiently and reliably identify exactly those patients for whom an intervention on the part of the physician or the caregiver is required.

Typical clinical scenarios are, for example, senile dementia and cerebral-organic psychosyndrome (HOPS). Many entities participate in the care of geronto-psychiatric patients. These entities generally act independently of one another in terms of time and place. First, there is the patient to be cared for. This can take place at home with the patient but also in an institution such as, for example, a hospital, a senior's home or a nursing home. The patient is cared for, for example by family members, outpatient nursing services, geriatric nurses, nurses, resident physicians or physicians of a clinic.

The number of entities makes communication more difficult, so that medical findings that require a reaction are lost in the chain of communication or arrive at the physician too late for effective assistance to the patient.

A preselection regrading which patients are candidates for care by an outpatient nursing service occasionally ensues by using an online video observation of the patient at home via which, in part, monitoring measures such as, for example, the application of ECG electrodes by the patient at home are implemented.

### SUMMARY OF THE INVENTION

An object of the present invention is to provide a system of the type initially described wherein, in a simple way, monitoring and evaluation of the condition of a geriatric-psychiatric patient are enabled despite a spatial separation between physician or nursing services and parties, physicians, care givers, patients and/or clinics interested information related to the patient's condition.

The above object is achieved in accordance with the principles of the present invention in a medical system for continuously monitoring geriatric-psychiatric patients in an ambient living environment (i.e. a living environment wherein the patient exhibits ambient behavior, as opposed to being fully bedridden), wherein at least one ambient behavior event on the part of the patient is continuously monitored, and data representing the number of occurrences of this event (or events) are transmitted to a system center, wherein the data are stored. The system center also stores reference values for the monitored behavior event (or events), and has an evaluation unit wherein the monitored number of such events is compared to the reference value. An alarm signal is generated if the monitored number of behavior events upwardly exceeds the reference value or values. This alarm signal is forwarded, via a routing device, to a reception device of a person in a response chain, who is intended to be notified in order to initiate remedial action on behalf of the monitored patient

The inventive system enables monitoring in an ambient living environment on the basis of “undesired events” such as, for example, states of confusion, falls, aggressivity, wandering, excessive periods of immobility or medication side effects. For example, a “virtual” nursing station is thus obtained at home by the patient.

Such a system is utilized, for example, in order to a trigger medical response based on simple monitoring measures that have conventionally been implemented at hospital area or the physician's practice, and to relocate the monitoring into the living environment of the patient or a nursing home. In particular, the system monitors three quantities: patient compliance, the actual undesired events and physician compliance. Alarms can thus be triggered when the patient exhibits confused states, aggressivity, medication side effects, periods of immobility, excessive falls or wandering and if the entity to be notified does not react adequately.

Measures that are required immediately in case of an illness can be initiated without delay when the alarm mechanism is configured such that it generates an alarm signal given an upper transgression, particularly a significant upward transgression, of representing data stored reference value limits, this alarm signal being conducted to a reception device of a person in a treatment chain or emergency chain.

Inventively, the alarm mechanism can be fashioned such that it generates an alarm signal when data fail to arrive, this alarm signal being conducted to a reception device at the patient, and/or such that it generates an alarm signal when reactions of the treatment chain to specifically identified values fail to occur, this alarm signal being conducted to a reception device of the emergency chain. It has proven advantageous for a routing device to be fashioned such that the alarm signal is conducted to a predetermined, selectable reception device in the process chain or such that the alarm signal is conducted by automatic routing to a reception device of the process chain that is defined by the routing mechanism taking the availability into consideration.

A fast and effective notification in case of emergency can be achieved when the routing mechanism includes a learning expert system that effects the notification of the process chain, for example notification of the family physician, calling the emergency physician, organizing the transport service and/or readying the clinic.

Unwanted false alarms are reduced or precluded when the evaluation mechanism has a learning expert system that interprets the data specifically related to an illness and/or problem on the basis of rule systems or on probabilities, the alarm signal being triggered on this basis.

### DESCRIPTION OF THE DRAWING

The single figure schematically illustrates a medical system for monitoring geriatric-psychiatric patients in an ambient living environment, constructed and operating in accordance with the principles of the present invention.

The figure shows an inventive system for continuously monitoring undesired events of a patient at the patient's home 1. The acquisition of undesired events ensues either automatically, for example by means of a detector 2, or manually by the patient or a caregiver. Acquisition devices disclosed by German OS 196 37 383 A or PCT Application WO 99/06979 A can serve as the detector 2. These acquired events can be forwarded to a system center 6 either directly or by a personal computer 3, by a fax machine 4 or by a telephone or cell phone 5. This, for example, can ensue via an ISDN network 7 to which the corresponding terminal devices are connected via an ISDN interface 8.

A gateway 9 is provided in the system center 6, the gateway 9 being connected to the ISDN network 7 via an ISDN interface 10. An Internet proxy server 1 1 for access to the Internet, an evaluation device 12 for the events, a patient data server 13 for administering the patient data and a communication server 14 as routing mechanism for collaboration of all components and forwarding of messages can be connected to the gateway 9. A data store 15 for the event data is connected to the evaluation device 12, and a databank 16 as storage device is connected to the patient data server 13.

The evaluation device 12 has a comparator for comparing the occurrence of events to reference value limits stored in the data store 15, and has an alarm mechanism for generating an alarm signal when the plurality of events upwardly exceeds stored rated value limits. The evaluation device 12 can differently evaluate the various events.

Reception devices such as, for example, a fax machine 20, personal computer 21 or a telephone 22 or a cell phone are connected to the system center 6. These belong to a physician response team or to a nursing service and, for example, can be arranged in a community practice 23 of physicians.

Further, a personal computer 24 at a practice of a primary physician is connected to the gateway 9 of the system center 6 via the ISDN network 7. In the system center 6, the medical data are read-in via standardized telecommunication interfaces and are stored long-term in the data storage 15, the evaluation device 12 evaluates the undesired events and the point-in-time of the acquisition in order to be able to send information messages. The data transmission ensues, for example, via the Internet or telephone network. The assigning of a patient identification number ensues via a security architecture.

All information that are required for the realization of the specific embodiments of the alarm generator and for a forwarding messages given the absence of the recipient can be merged in the system center 6.

The terminal devices 2 through 5 for the patient serve for the acquisition of the undesired events at the patient and for the transfer of the data to the system center 6. The data transfer 25 of the event data to the server in the system center 6 can ensue with the detector 2 itself or can be realized via the input possibilities described below.

A personal digital assistant (PDA) or a lap top is provided for the care givers, all patient data of patients that are visited by this nursing service being input thereinto. The synchronization of the data can ensue immediately, for example, by cell phone/Internet connection, or at a later point in time when the nurse has returned to the office or practice.

The system center 6 serves the purpose of accepting medical data via one of the telephone communication interfaces and storing thereof in the data store 15. It should also effect a further-processing of the medical data with the assistance of the evaluation device 12 for the undesired events with the alarm mechanism and the data store 15. An output of the data acquired in the data store 15 to one of the terminal devices for physicians ensues via a telecommunications interface.

The alarm mechanism triggers an alarm in the evaluation device 12 given the presence of one of the event constellations such as the failure of data to arrive, undesired events or failure of a reaction to the generated alarms. An alarm 26 is thereby forwarded to the terminal devices 20 through 22 of the community practice 23 due to an upward transgression of the plurality of undesired events relative to the rated values. An alarm 27 to the patient is triggered due to a lack of data. In the practice, the physician can call the data 28 stored in the data store 15 with the personal computer 24.

The evaluation device 12 evaluates whether the undesired events or their plurality are suspicious in view of the geronto-psychiatric patient. As criteria, limits are taken from the literature and are stored in the data store 15. Further, individual limits for the patient can be defined by the attending physician.

An expert system that interprets the event data specifically related to illness and problem on the basis of rule systems or based on probabilities can be utilized for this purpose. An individualization of the expert system to the patient can thereby be provided, i.e. the expert system becomes more and more familiar with the patient the system is monitoring during the monitoring process; to that end, a learning system always makes prognoses about future event data to be anticipated, comparing these to the true event data. An individualized monitoring is thus accomplished.

In the case of complex alarms, an expert system can be utilized that assumes the process chain, instructions to the patient, notification of the nursing service or family physician, calling the emergency physician, organizing the transport service and/or preparing the clinic taking the availability of the alarm recipients into consideration.

The process chain is the totality of participating persons or institutions. This includes the patient and the patient's family members, the treatment chain with outpatient nursing services, geriatric nurses, nurses, resident physicians or clinic physicians.

Alarms can be generated with different urgency levels dependent on the urgency of a reaction, for example extremely urgent, urgent, routine or standard. Which event data lead to which urgency level can be defined with the same mechanisms as the evaluation of the event data and can be stored in the data store 15.

The inventive system creates a “virtual” nursing station at home by the patient that comprises a central alarm generator system that generates alarms given:

Faulty patient compliance (anticipated event data from the patient fail to arrive)

Upward transgression of thresholds (i.e., the event data lie in a pathological range)

Faulty physician compliance (anticipated reaction to the alarm by the physician fails to occur).

This inventive system for home monitoring serves the purpose of recognizing a need for medical or nursing treatment. To that end, the number and the nature of undesired events are acquired at the patient and communicated to the system.

The following can be undesired events, whereby the date and the time of day are also respectively acquired:

Confused states

Falls

Aggressivity toward roommates, care givers or family members

Aimless wandering

Excessive periods of immobility and/or

Typical side effects of medications that indicate an overdose When the number of undesired events exceeds a reference value limit, which can be different for each type of event, or when the undesired event is an “absolute” undesired event, then the system effects the setup of an asynchronous communication between physician, nursing services such as outpatient, care givers or geriatric nurses, patients and/or family members of the patient.

The inventive system can be utilized at home with the patient, in senior's homes or in nursing homes.

Although modifications and changes may be suggested by those skilled in the art, it is the intention of the inventor to embody within the patent warranted hereon all changes and modifications as reasonably and properly come within the scope of his contribution to the art.

We claim as our invention:

1. A medical system for monitoring a geriatric-psychiatric patient in an ambient living environment, wherein the patient exhibits behavior events associated with a geriatric-psychiatric condition, said medical system comprising:
a monitor located at said ambient living environment for continuously monitoring at least one of said behavior events and for generating monitoring data representing a number of occurrences of said at least one behavior event;
a system center located remote from said ambient living environment, said system center having a system center reception device to which said monitoring data are supplied by said monitor, a memory for storing said monitoring data, a memory for storing a reference value for said at least one behavior event, an evaluation unit for comparing said monitoring data to said reference value and for generating an alarm signal if the number of occurrences of said at least one behavior event represented by said monitoring data upwardly exceeds said reference value;
a reception device located at a person in a response chain responsible for taking remedial action on behalf of said patient; and
said system central also including a routing device for routing said alarm signal to said reception device of said person in said response chain and for generating a further alarm signal if said person in said response chain fails to respond to said alarm signals supplied to said reception device.

2. A medical system as claimed in claim 1 wherein said evaluation device generates said alarm signal given any upward transgression of said number of occurrences of said behavior event represented by said monitoring data relative to said reference value.

3. A medical system as claimed in claim 1 wherein said evaluation device generates said alarm signal given only a significant upward transgression of said number of occurrences of said behavior event represented by said monitoring data relative to said reference value.

4. A medical system as claimed in claim 1 wherein said system center further includes an alarm device which generates an alarm signal if said monitoring data fail to arrive at said reception device at said system central, and wherein said medical system further comprises a reception device at said patient to which said alarm signal is supplied if said monitoring data fail to arrive.

5. A medical system as claimed in claim 1 wherein said routing device automatically routes said alarm signal to said reception device of said person in said process chain, dependent on availability of said person in said process chain.

6. A medical system as claimed in claim 1 wherein said routing device comprises an expert learning system for routing said alarm signal to said person in said process chain.

7. A medical system as claimed in claim 1 wherein said evaluation device comprises an expert learning system that interprets said monitoring data and generates said alarm signal dependent on said interpretation.
